(19) United States
(12) Patent Application Publication
(10) Pub. No.: US 2008/0303751 A1
(43) Pub. Date: Dec. 11, 2008

(54) IMAGE DISPLAYING APPARATUS AND METHOD FOR DISPLAYING IMAGES AND ADDITIONAL INFORMATION

(75) Inventors: Xiao-Guang Li, Shenzhen (CN); Kuan-Hong Hsieh, Shenzhen (CN); Li Wang, Shenzhen (CN)

Correspondence Address: NORTH AMERICA INTELLECTUAL PROPERTY CORPORATION, P.O. BOX 506, MERRIFIELD, VA, 22116, US

(73) Assignees: HONG FU JIN PRECISION INDUSTRY (Shen Zhen) CO., LTD., Shenzhen City (TW); HON HAI PRECISION INDUSTRY CO., LTD., Taipei Hsien (TW)

(21) Appl. No.: 12/134,217

(22) Filed: Jun. 6, 2008

(30) Foreign Application Priority Data
Jun. 8, 2007 (CN) 200710074767.9

(51) Int. Cl. G09G 3/20

(52) U.S. Cl. 345/55

(57) ABSTRACT

An image displaying apparatus for displaying images and additional information is provided. The image displaying apparatus includes a display unit; an image data obtaining unit for obtaining image data of an image from a storage; an additional information obtaining unit for obtaining additional information; a display controller for displaying the image and additional information on the display unit in two display modes. In a first display mode, the additional information is semi-transparent or outlined as it overlaps the image, and in a second display mode, the additional information is highlighted and overlaps the image. The image displaying apparatus further includes a mode switching unit for signaling the display controller to switch between the first display mode and the second display mode. A related method is also provided.

### BACKGROUND

1. Technical Field

The present invention relates to image displaying apparatuses and methods thereof, and particularly to an image displaying apparatus and method for displaying images and additional information.

2. General Background

Generally, whether using a traditional photo frame to display a paper photo, or using a digital photo frame to display a digital photo, people may like to record information associated with the photo, such as when and where the photo was taken, who the subjects were, and a brief caption describing the photo, among other information that may help to fully preserve the captured moment.

Photo-related information is typically recorded with hand-written notes on the back of paper photos. However, written notes are not applicable for digital photos. Although many cameras have the capability of automatically applying a date/time stamp to digital photos, the date/time stamp generally has a very small font size that cannot be adjusted, thereby creating inconvenience for people with poor eyesight. Furthermore, digital cameras typically are not capable of recording and printing information aside from the date/time stamp associated with each photo.

Newer digital photo frame models are sometimes capable of providing real calendar/time information, which is generally displayed overlapping the photos in a very small font size in order to preserve the appearance of the digital photo. This, however, can be inconvenience to people with poor eyesight.

What is needed, therefore, is an image displaying apparatus and method which can solve the problem mentioned above.

### SUMMARY

An image displaying apparatus for displaying images and additional information is provided. The image displaying apparatus includes a display unit; an image data obtaining unit for obtaining image data of an image from a storage; an additional information obtaining unit for obtaining additional information; a display controller for displaying the image and the additional information on the display unit, therein the additional information is semi-transparent (or outlined) and overlaps the image in a first display mode, and the additional information is highlighted and overlaps the image in a second display mode; and a mode switching unit for signaling the displaying apparatus controller to switch between the first display mode and the second display mode.

Other advantages and novel features will be drawn from the following detailed description with references to the attached drawings.

### BRIEF DESCRIPTION OF THE DRAWINGS

The components of the drawings are not necessarily drawn to scale, the emphasis instead being placed upon clearly illustrating the principles of the image displaying apparatus and method for displaying images and additional information. Moreover, in the drawings, like reference numerals designate corresponding parts throughout the several views.

FIG. 1 is an isometric view of an image displaying apparatus capable of displaying images and additional information.

FIG. 2 is an isometric view, showing the image displaying apparatus of FIG. 1, displaying an image and additional information in a first display mode.

FIG. 3 is an isometric view, showing the image displaying apparatus of FIG. 1, displaying the image and additional information in a second display mode.

FIG. 4 is a schematic diagram of hardware employed for displaying the image and additional information in accordance with a first embodiment of the present invention.

FIG. 5 is another isometric view of the image displaying apparatus of FIG. 1, showing that the image displaying apparatus is further capable of editing additional information.

FIG. 6 is an exemplary user interface (UI) of the image displaying apparatus of FIG. 1 for editing the additional information.

FIG. 7 is a schematic diagram of hardware employed for processing and storing the edited additional information.

FIG. 8 is a schematic diagram of hardware employed for displaying the image and additional information in accordance with a second embodiment of the present invention.

FIG. 9 is a schematic diagram of hardware employed for displaying the image and additional information in accordance with a third embodiment of the present invention.

FIG. 10 is a schematic diagram of hardware employed for displaying the image and additional information in accordance with a fourth embodiment of the present invention.

FIG. 11 is a flowchart of a method for displaying images and additional information.

FIG. 12 is a flowchart of another method for displaying images and additional information.

### DETAILED DESCRIPTION OF THE EMBODIMENTS

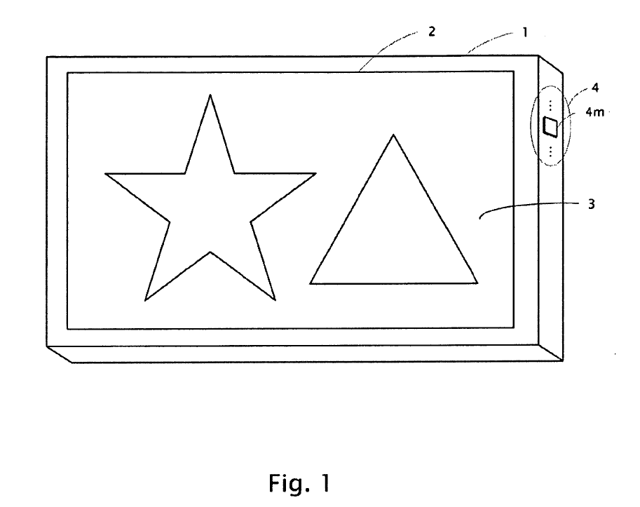

FIG. 1 shows an isometric view of an image displaying apparatus 1 capable of displaying images and additional information. The image displaying apparatus 1 shown is a digital photo frame and includes a display unit 2 configured for displaying images and additional information in a display area 3 thereof. The image displaying apparatus 1 further includes input units 4 configured for receiving input from users, in order to control the image displaying apparatus 1. The input units 4 include a mode switching actuator 4m. The mode switching actuator 4m is shown in FIG. 1 and is configured for triggering the image displaying apparatus 1 to switch between two display modes.

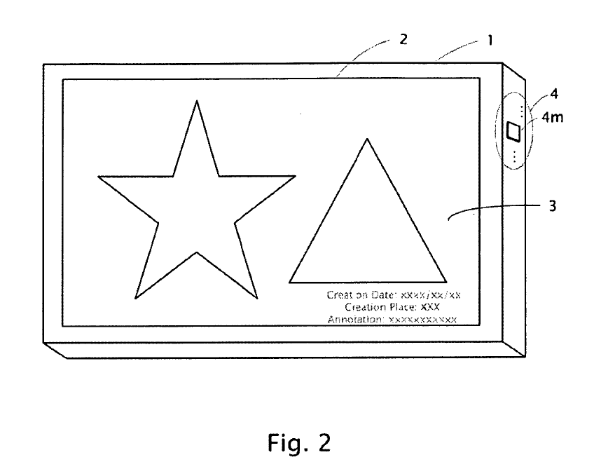

FIG. 2 shows the image displaying apparatus 1 displaying an image and additional information in a first display mode. The additional information is displayed overlapping the image. The additional information is semi-transparent or outlined and allows the image to be distinctly viewed through the additional information. Moreover, the additional information does not obscure the image. A font size of the additional information is small and only a portion of its content is displayed, thereby reducing the additional information's display area.

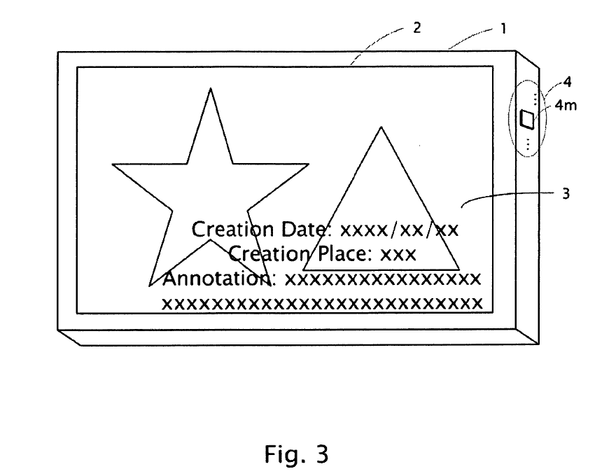

FIG. 3 shows the image displaying apparatus 1 displaying the image and additional information in a second display mode. The entire content of the additional information is highlighted and overlaps the image. Generally, highlighting the additional information may further include enlarging the font size of the additional information to a preset ratio or value, and coloring the additional information to clearly contrast it with a main hue of the image. Highlighting the additional information allows users to clearly view the additional information in the second display mode.

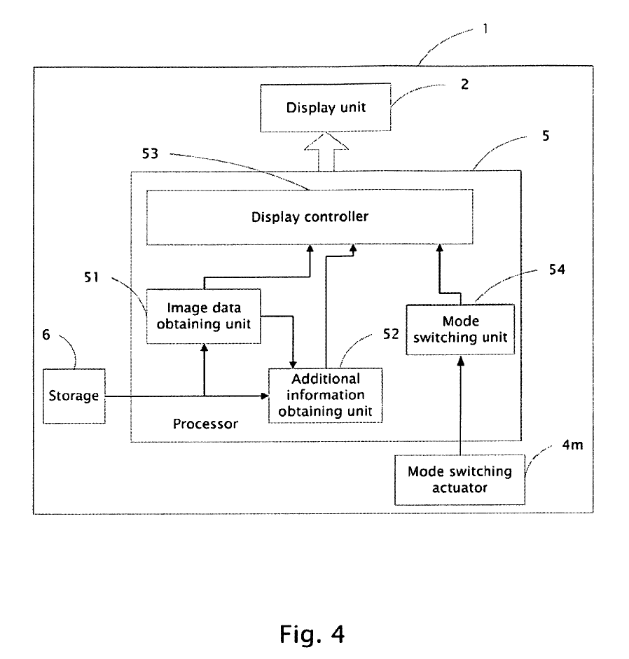

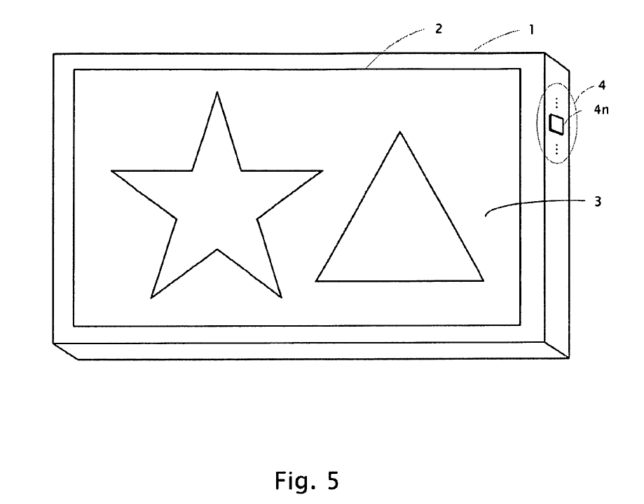

Referring to FIG. 4, hardware employed for displaying the image and additional information in the two display modes in accordance with a first embodiment is shown. In the first embodiment, the additional information includes image-related information such as creation date/time and pre-stored textual memos. The image-related information may be edited via the image displaying apparatus 1 if the image displaying apparatus 1 is equipped with an information editing function as shown in FIG. 5. However, when the image displaying apparatus 1 is not equipped with such an information editing function, the image-related information may be edited via other electronic devices that are capable of editing information of images, which is then transmitted to the image displaying apparatus 1. A processor 5 is incorporated in the image displaying apparatus 1 and includes an image data obtaining unit 51 and an additional information obtaining unit 52.

The image data obtaining unit 51 is configured for obtaining image data of the image from a storage 6 and transmitting the image data to a display controller 53, so that the image is displayed in the display area 3. The additional information obtaining unit 52 is configured for obtaining image-related information of the image from the storage 6, and transmitting the image-related information to the display controller 53, so that the additional information overlaps the image. The processor 5 also includes a mode switching unit 54 configured for receiving mode switching signals from the mode switching actuator 4m and accordingly signaling the display controller 53 to display the image and additional information between the first and second display modes.

Referring to FIG. 5, the input units 4 further include an image-related information editing actuator 4n. The image-related information editing actuator 4n is configured for actuating an image-related information editing user interface (UI) to display on the display area 3. The image-related information editing UI is provided for adding or editing the image-related information of the image.

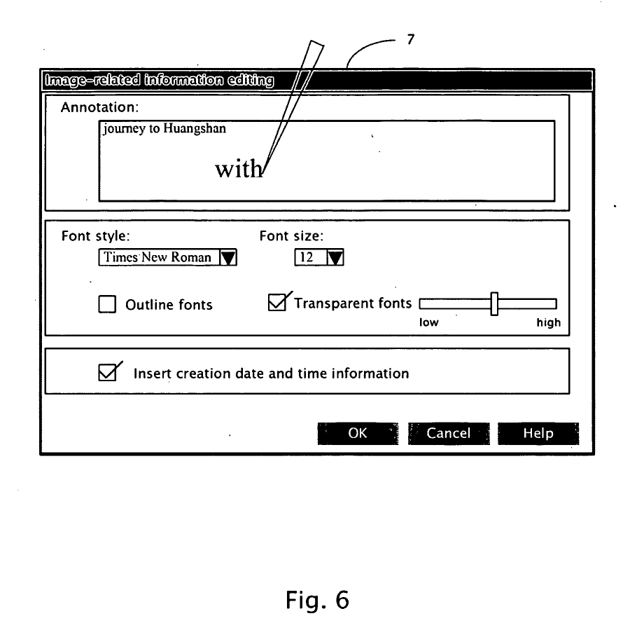

Referring to FIG. 6, a UI example 7 of the image-related information editing UI mainly includes three sections. A first section is provided for receiving a textual memo of the image. The textual memo in this example is inputted using a stylus. A second section is provided for selecting whether to add a creation date/time of the image. For example, if the image is a photo and the second section is selected, a creation date/time of the photo is obtained from the photo data and added into the image-related information. A third section is provided for configuring font settings of the image-related information, including a font style, a font size, and other various options such as “outline fonts” or “transparent fonts”. If “transparent fonts” is selected, a transparency level bar is activated wherein the transparency level can be adjusted via a sliding block along the transparency level bar. An “OK” button is provided for confirming the settings of the image-related information. A “Cancel” button is provided for discarding the changes that have been made in the settings screen. A “Help” button is provided for providing help while configuring the settings.

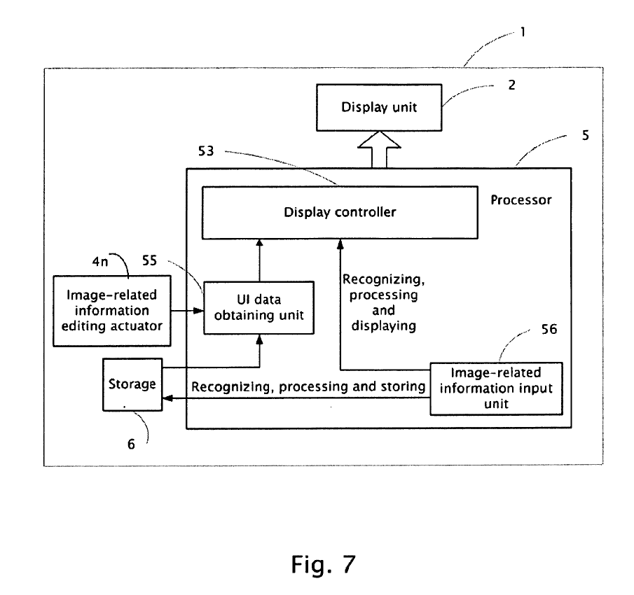

Referring to FIG. 7, hardware employed to deal with the settings of the image-related information is shown. The storage 6 stores UI data of the UI example 7. The processor 5 includes a UI data obtaining unit 55. The UI data obtaining unit 55 responds to signals from the image-related information editing actuator 4n, obtains the UI data from the storage 6 and transmits the UI data to the display controller 53. The display controller 53 then displays the UI example 7 in the display area 3. The processor 5 also includes an image-related information input unit 56 configured for receiving the edited image-related information and character display parameters (e.g., the font setting conducted in the third section of the UI example 7) input via the UI example 7. The edited image-related information and the character display parameters are recognized and processed by the processor 5, and then are displayed on the UI example 7 by the display controller 53, thus giving a visual feedback to the users.

The edited image-related information and the display character parameters are stored in the storage 6 after the “OK” button in the UI example 7 has been pressed. The processor 5 may generate an image-related file (not shown) to record the edited image-related information and the character display parameters. The image-related file is stored in the storage 6 associated with an image data file of the image. For example, the file may have a same prefix as a name of the image data file. When the image is to be displayed, the processor searches the storage 6 for both the image data file and the image-related file and displays the image and the edited image-related information simultaneously. The edited image-related information is displayed in compliance with the character display parameters in the first display mode.

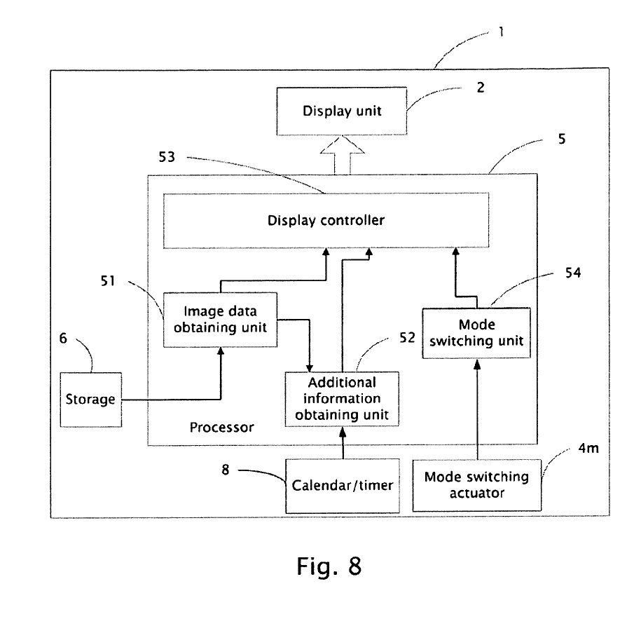

Referring to FIG. 8, hardware employed for displaying the image and the additional information in the two display modes in accordance with a second embodiment is shown. In the second embodiment, the additional information includes real calendar and time information provided from a calendar/timer 8. The additional information obtaining unit 52 obtains the real calendar and time information from the calendar/timer 8 and transmits the information to the display controller 53, so that the real calendar and time information overlaps the image in either of the two display modes.

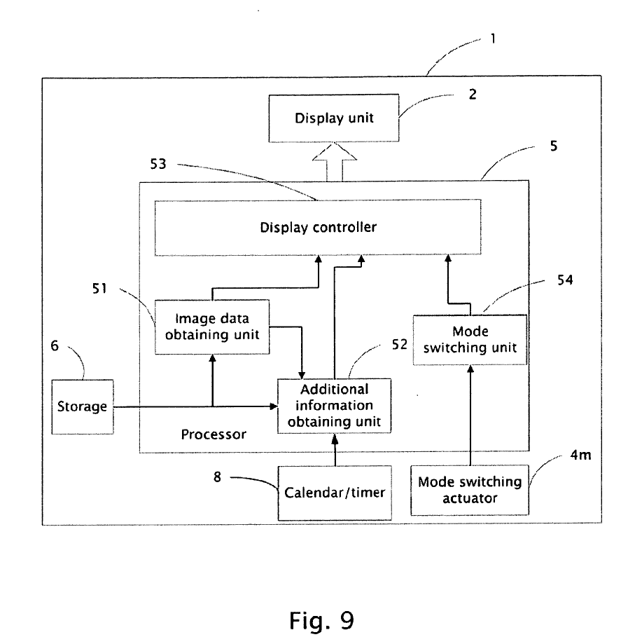

Referring to FIG. 9, hardware employed for displaying the image and additional information in the two display modes in accordance with a third embodiment is shown. In the third embodiment, the additional information includes both the image-related information and the real calendar and time information. The additional information obtaining unit 52 obtains the image-related information from the storage 6 and the real calendar and time information from the calendar/timer 8 and transmits both of them to the display controller 53, so that the image-related information and the real calendar and time information simultaneously overlaps the image in either of the two display modes.

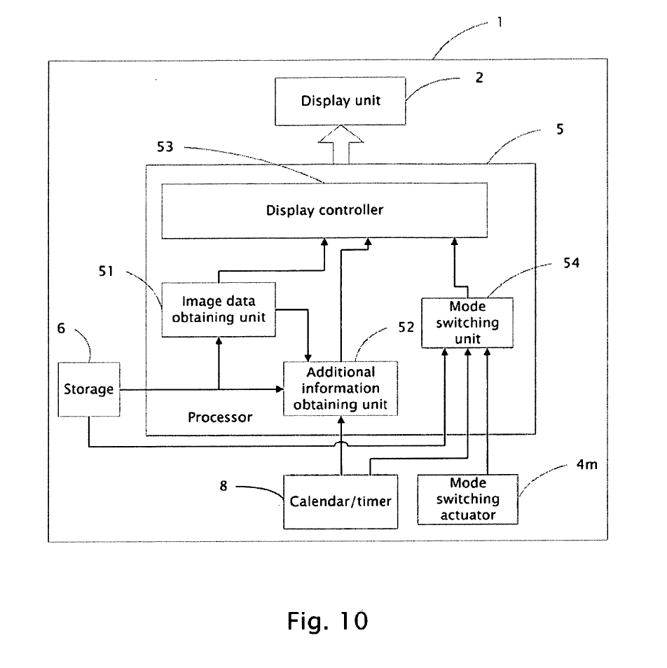

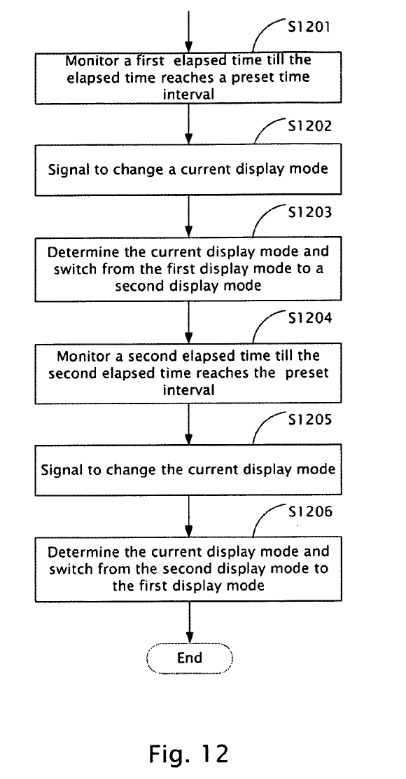

Referring to FIG. 10, hardware employed for displaying the image and the additional information in the two display modes in accordance with a fourth embodiment is shown. In the fourth embodiment, the storage 6 further stores one or more preset time intervals. The mode switching unit 54 obtains real time information from the calendar/timer 8 and the preset time intervals from the storage 6 and accordingly signals the display controller 53 to switch between the two display modes when the image and the additional information in the first or second display mode is displayed a corresponding preset time interval (described in detail below in relation to FIG. 12).

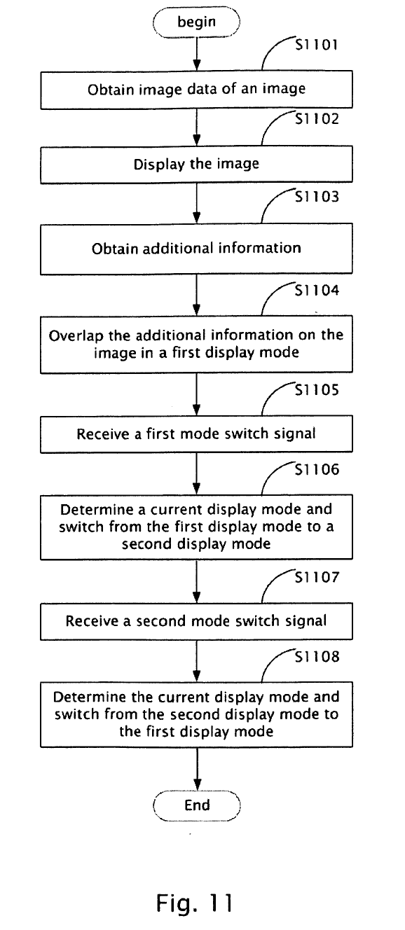

Referring to FIG. 11, which shows a flowchart of a method for displaying the image and additional information. Initially, in step S1101, the image data obtaining unit 51 obtains the image data of the image from the storage 6 and transmits the image data to the display controller 53. In step S1102, the display controller 53 displays the image on the display unit 2 in accordance with the image data. In step S1103, the additional information obtaining unit 52 obtains the additional information, which includes the image-related information and/or the real date and time information, and transmits the additional information to the display controller 53. In step S1104, the display controller 53 overlaps the additional information on the image in the first display mode. Namely, the display controller 53 controls the additional information to be semi-transparent or outlined so that the additional information does not affect the appearance of the image. The display controller 53 simultaneously generates a current display mode record to record a current display mode. The current display mode here is the first display mode.

In step S1105, the mode switching unit 54 receives a first mode switching signal from the mode switching actuator 4m and signals the display controller 53 to change the current display mode. In step S1106, the display controller 53 determines the current display mode according to the current display mode record and switches the current display mode from the first display mode to the second display mode. Namely, the display controller 53 highlights the additional information, so that the additional information can be clearly seen by the users. Generally, highlighting the additional information may include enlarging its font size to a preset ratio or value, and/or coloring the additional information to clearly contrast it with the main hue of the image. The display controller 53 simultaneously updates the current display mode record to record the second display mode, which is now the current display mode. In step S1107, the mode switching unit 54 receives a second mode switching signal from the mode switching actuator 4m and signals the display controller 53 to change the current display mode. In step S1108, the display controller 53 determines the current display mode according to the current display mode record and switches the current display mode from the second display mode to the first display mode.

Referring to FIG. 12, which shows a flowchart of another method for displaying the image and additional information. The method is similar to steps S1101-S1104 of the method of FIG. 11. FIG. 12 only shows steps that are executed after step S1104 and begin with step S1201. In step S1201, the mode switching unit 54 monitors a first elapsed time based on the real time information provided by the calendar/timer 8. The procedure proceeds to step S1202 when the first elapsed time reaches a preset time interval. In step S1202, the mode switching unit 54 signals the display controller 53 to change the current display mode. In step S1203, the display controller 53 determines the current display mode according to the current display mode record maintained and updated by the display controller 53 and switches the current display mode from the first display mode to the second display mode. In step S1204, the mode switching unit 54 monitors a second elapsed time based on the real time information provided by the calendar/timer 8. The procedure proceeds to step S1205 when the second elapsed time reaches the preset time interval (or a second preset time interval). In step S1205, the mode switching unit 54 signals the display controller 53 to change the current display mode. In step S1206, the display controller 53 determines the current display mode according to the current display mode record and switches the current display mode from the second display mode to the first display mode.

Although the present invention has been specifically described on the basis of preferred embodiments thereof, the invention is not to be construed as being limited thereto. Various changes or modifications may be made to the embodiments without departing from the scope and spirit of the invention.

What is claimed is:

1. An image displaying apparatus for displaying images and additional information, comprising:
a display unit;
an image data obtaining unit configured for obtaining image data of an image from a storage;
an additional information obtaining unit configured for obtaining additional information;
a display controller configured for displaying the image and the additional information on the display unit, wherein the additional information is semi-transparent or outlined as it overlaps the image in a first display mode, and the additional information is highlighted and overlaps the image in a second display mode; and
a mode switching unit configured for signaling the display controller to switch between the first display mode and the second display mode.

2. The image displaying apparatus as claimed in claim 1, further comprising a mode switching actuator configured for producing and transmitting a mode switching signal to the mode switching unit, so that the mode switching unit signals the displaying apparatus controller to switch between the first display mode and the second display mode.

3. The image displaying apparatus as claimed in claim 1, wherein the additional information comprises image-related information of the image.

4. The image displaying apparatus as claimed in claim 1, further comprising a calendar/timer configured for providing real calendar and timer information.

5. The image displaying apparatus as claimed in claim 4, wherein the additional information comprises the real calendar and timer information.

6. The image displaying apparatus as claimed in claim 4, wherein the mode switching unit is further configured for monitoring an elapsed time of the image and the additional information being displayed in one of the first and second display modes based on the real time information provided by the calendar/timer and signaling the display controller when the elapsed time reaches a corresponding preset time interval.

7. The image displaying apparatus as claimed in claim 1, wherein in the first display mode displays only a portion of the content of the additional information.

8. The image displaying apparatus as claimed in claim 7, wherein in the second display mode displays the entire content of the additional information.

9. The image displaying apparatus as claimed in claim 1, wherein the additional information in the second display mode is highlighted by enlarging a font size thereof for a preset ratio or to a preset value.

10. The image displaying apparatus as claimed in claim 1, wherein the additional information in the second display mode is highlighted by coloring the additional information to contrast it with a main hue of the image.

11. A method for displaying images and additional information thereof on a display unit, comprising:
obtaining image data of an image from a storage and displaying the image on the display unit;
obtaining additional information and controlling the additional information to be semi-transparent or outlined as it overlaps the image in a first display mode;
receiving a mode switching signal; and
highlighting the additional information and overlapping the additional information on the image in a second display mode.

12. The method as claimed in claim 11, further comprising:
receiving another mode switching signal; and
overlapping the additional information on the image in the first display mode.

13. The method as claimed in claim 11, further comprising determining a current display mode of the image and additional information according to a display mode record each time a mode switching signal is received.

14. The method as claimed in claim 12, further comprising determining a current display mode of the image and additional information according to a display mode record each time a mode switching signals is received.

15. The method as claimed in claim 11, wherein the additional information is highlighted by enlarging a font size thereof to a preset ratio or a preset value.

16. The method as claimed in claim 11, wherein the additional information is highlighted by coloring the additional information to contrast it with a main hue of the image.

17. The method as claimed in claim 11, wherein the additional information comprising image-related information.

18. The method as claimed in claim 11, wherein the additional information comprising real calendar and time information.
